(19) United States
(12) Patent Application Publication
(10) Pub. No.: US 2010/0291908 A1
(43) Pub. Date: Nov. 18, 2010

(54) CELLULAR PHONE SYSTEM FOR PROVIDING INFORMATION RELATING TO OBJECTS OF TOURISM

(76) Inventor: Barna Heder, Budapest (HU)

Correspondence Address: BIRCH STEWART KOLASCH & BIRCH, PO BOX 747, FALLS CHURCH, VA, 22040-0747, US

(21) Appl. No.: 12/744,323

(22) PCT Filed: Nov. 12, 2008
(86) PCT No.: PCT/HU08/00132

§ 371 Date: Jul. 7, 2010

(30) Foreign Application Priority Data
Nov. 23, 2007 (HU) P0700749

(51) Int. Cl. H04M 3/42

(52) U.S. Cl. 455/414.1

(57) ABSTRACT

Cellular phone or internet based system for providing information relating to objects of tourism. The system comprising subscribers' cellular phones or handheld computer devices provided with a SIM card; information database containing information blocks; and assign codes for assigning said information blocks to said objects. One or more information blocks can be selected from said database on the basis of said assign code entered into the cellular phone or hand-held computer device by a user. Information blocks contain at least textual information in audio or visual form, and the content of said information blocks are activated by entering at least said assign code into the cellular phone or hand-held computer device by the user, the use of said assign codes is enabled by an activating code transmitted to a tourist information supplier previously.

The invention relates to a cellular phone system for providing information relating to objects of tourism, particularly for presenting textual information either in audio or visual form for individual tourists, visitors, foreigners or groups of these. The system according to the invention comprises subscribers' cellular phones or hand-held computer devices provided with a SIM card; information database containing information blocks; and codes for assigning the information blocks to the objects, wherein one or more information blocks can be selected from the database on the basis of the assign code entered into the cellular phone or hand-held computer device by a user.

Systems for providing information relating to special objects (e.g. buildings, sights of a city, etc.) for people visiting a given area are known. These systems are used for example in museums for presentation of the exhibits as it is disclosed in Hungarian patent application PO402331. In this document a mobile compact information device is disclosed. The device is adapted to display an information subset which is selected on the basis of auxiliary information read manually from a main database. The device comprises a manual reader unit, a selecting unit, an interface and a display unit. The display unit can be a mobile phone or a hand-held computer device.

Patent application DE3521220 describes a process for playing back information along a route. According to this document units are located at determined sections of a path in order to supply information to the people going along the path. This solution can be used for purposes of tourism.

Patent application JP2005257378 discloses a method and system for providing a navigation service and guidance service for a visitor to a museum or an art museum. So called RFID-TSG elements are used for determining the positional information of a visitor. The visitor has a device by means of which he can transmit another ID through radio frequency transmission identifying the place/exhibit he is looking for. A central server based on the positional information of the visitor and the exhibits navigates the visitor to the required place. This solution can be used for guiding the tourists on a certain route.

Neither of these solutions ensure for the user independence in space and time, moreover, a special device is needed for providing the information. Solutions are known in which an information packet—typically audible information—is given to the user so that an information block is selected from a database which is stored in a special device. Such devices can be rent and used as audio guides for individuals. The objects or sights are provided with an alphanumeric code, for example a number, and when the user enters this number into the device, the selected Information block is presented (told). A disadvantage of these devices is that they can be used only in places where the objects of interest are found in a determined limited area. Another disadvantage is that the user should learn how to use the device which takes time. A further disadvantage is that visitors must pay for the rent and the device must be returned to a determined place. In order to eliminate the aforementioned disadvantages the object of the present invention is to provide a system in which information relating to objects of tourism is supplied through a user's own device, the system is adapted to cover larger physical areas, for example a town, region.

The invention is based on the realization that most of the tourists have a cellular phone operated by a service provider or a hand-held computer device which devices are suitable for supplying—at any time selected by the user—audio-visual information relating to a determined object, typically an object in the open air, for example buildings, statues or other sights.

Generally, the present invention is embodied by a system according to the preamble in which the information blocks contain at least textual information in audio or visual form, and the content of the information blocks are activated by entering at least the assign code into the cellular phone or hand-held computer device by the user, the use of the assign codes is enabled by an activating code transmitted to the tourist information supplier previously. The tourist information supplier can be the mobile service provider.

A detailed description of the invention will be given with reference to the accompanying drawings, in which:

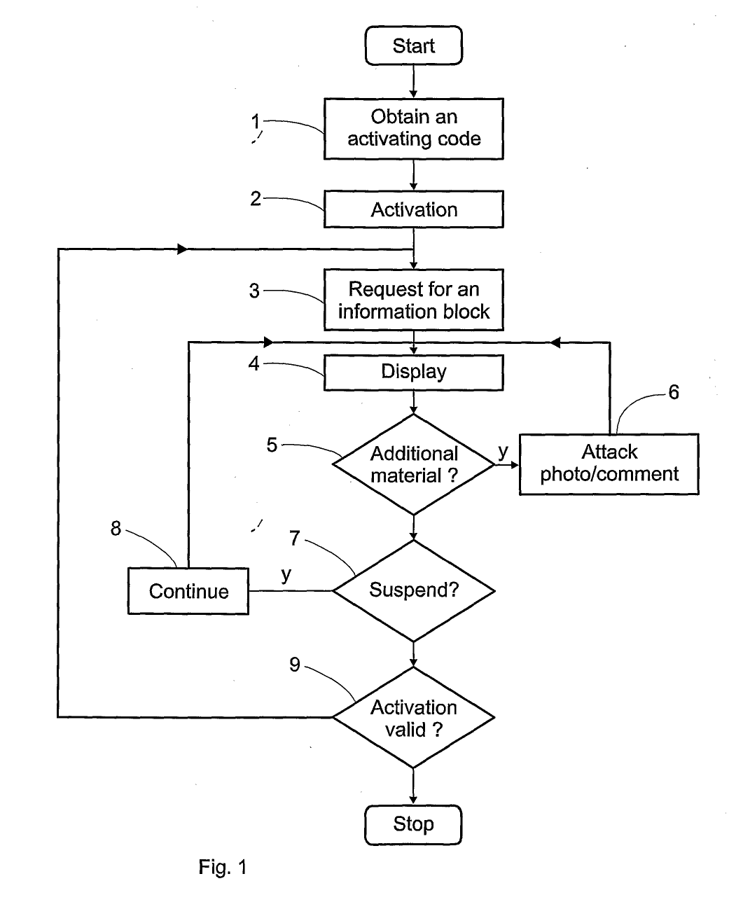

FIG. 1 is a flowchart showing the steps of the method according to the invention in case of on-line execution, and

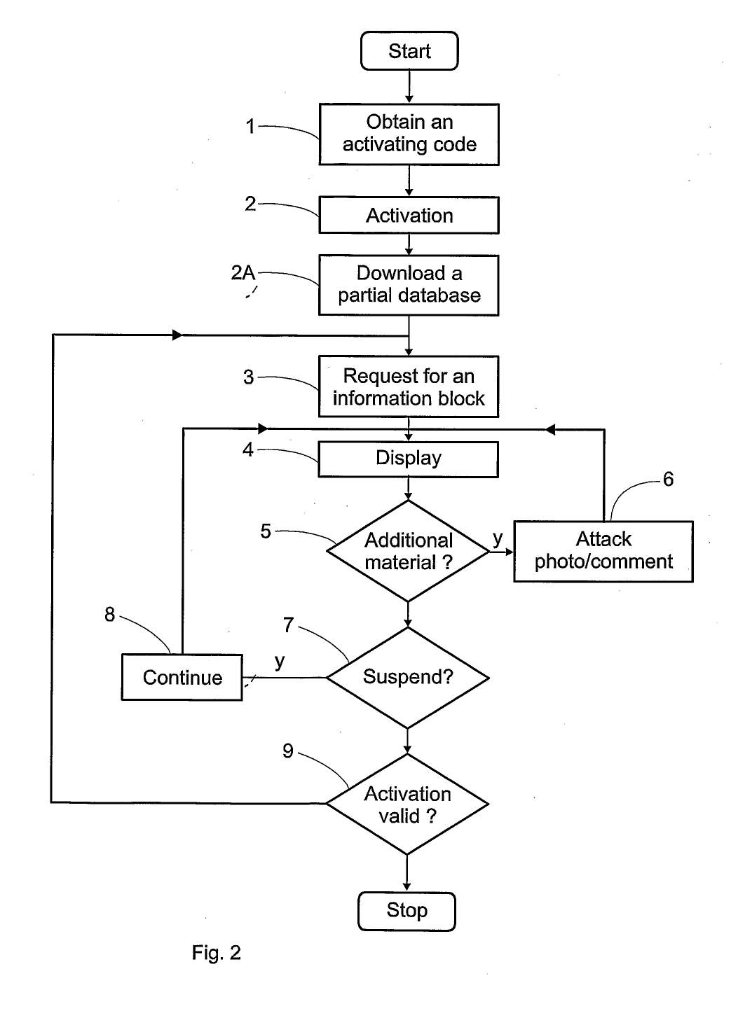

FIG. 2 is a flowchart showing the steps of the method according to the invention in case of an alternative, off-line execution.

FIG. 1 shows the steps of the method according to the invention. In step 1 the owner of the cellular phone or a hand-held computer device obtains (purchases) a suitable activating code. For example he can buy a card similar to the known pre-paid rechargeable telephone cards. In an alternative embodiment the code may be purchased through the internet. This activating code can be entered into the cellular phone or hand-held computer device of the user when access to the tourist information service is required. In the present case the activating code or the card carrying the code can be purchased at tourist centers, offices or other agencies for example at the offices of the mobile service supplier. In one embodiment the card makes access to the information service possible for a certain period of time in an on-line manner. In another embodiment access to a certain number of information blocks is made possible. In both cases the basic functions of the telephone are utilized while they are continuously guaranteed. In other words, calls or messages can be initiated or received with the device.

In respect of the present invention the term hand-held computer is used for a device adapted for communication and bidirectional data transfer with a regional center of a wireless system (WIFI). Such devices are e.g. the palmtop computers, PDAs or other devices of computer technology adapted to access services of this type.

In step 2 the user accesses the service by using the activating code. This is important as this is the starting point from which the available period of time or in another case the number of the accessible information blocks ensured by the conditions implied in the activating code can be determined. The activating code may be transferred to the mobile service provider e.g. through SMS or by dialing a certain number and entering the code on the dial pad or in case of a hand-held computer through the internet or by e-mail.

Then in step 3 the information blocks are requested so that the assign code of a given object is entered. This assign code may be embodied in different forms. In a possible embodiment the codes are characters on a signboard positioned in the vicinity of the objects (building, sights, etc.) in a place which is well visible for the user (visitor),If the visitor is an authorized user i.e. he has paid for the service, he can activate the request for the required information block by entering the assign code into his cellular phone or hand-held computer. Transmission of the information blocks to the device of the user can take place through SMS or even

GPRS if the blocks are longer. In a certain case transmission can also take place partially or entirely through the internet. The blocks may contain textual information in the form of characters or audio information in the form of voice message. Naturally, in the latter case the same technology is used for transmission as in case of normal telephone calls and voice messages. Further, the requested information block may also contain visual information typically in the form of a photo or illustration. The photo may represent the object itself while the illustration may be a map showing the location and accessibility of the object.

In step 4 the received information block is displayed. Display may be in the form of speech transmitted on-line through a voice channel or in the form of characters appearing on the display.

In a preferred embodiment in step 5 the user can decide whether to add additional material e.g. photo and/or comment to the information block. Advantageously, the additional material can be prepared with the user's cellular phone or hand-held computer during or after the display of the information block, and in step 6 it can be attached to the information block stored in the device. Then the user can return to step 4 and display another information block.

The displayed information—particularly when it is in the form of speech (audio information) —can be interrupted if needed. The virtual guiding can be suspended n step 7 when the basic functions of the cellular phone or hand-held computer must be used for example when a call or message is received or initiated. In case of an incoming call the display can be suspended automatically.

In step 8 display of the interrupted information block can be continued. In an alternative embodiment in step 8 decision can be made whether to start again displaying the information block from the beginning instead of continuing it.

In step 9 it is determined whether the activation is still valid, i.e. the time limit or the number of the permitted information blocks is not exceeded. If valid state is determined, the user may return to step 3 and transmit a request for another information block by entering a new assign code. If in step 9 it is determined that the activation expired, the process ends and can only be started again after obtaining (purchasing) a new activating code.

The above process can be repeated until the determined time expires or the determined number of the available information blocks is exceeded.

In an alternative embodiment instead of supplying the information on-line subsequent to entering the required assign code, the user receives the information by activating a corresponding information block of a partial database installed and stored in the memory of the hand-held computer, cellular phone or SIM card. This process is shown in FIG. 2. It is different from the process shown in FIG. 1 in that the information relating to a certain set of objects is stored in the internal memory of the device. In this case following the activation (step 2) the user must download a partial database in step 2A. This partial database contains several information blocks. The code used for downloading can be the activating code itself. In this alternative embodiment a higher capacity internal memory is needed.

However, the information which can be stored on a card or phone will probably relate to fewer objects than in the case of on-line transmission of FIG. 1. Still, this solution is advantageous when sights of a well defined area are introduced. Then the information is supplied in off-line manner, i.e. it is not necessary for the information supplier, e.g. the mobile service provider to participate in the exchange of messages when the information block is requested. In this manner the costs of the data transmission can be reduced, moreover, the information is still available for example when the user is not in the coverage area or the service is not available for some other reasons. Naturally, as it has already been mentioned, a higher capacity memory is needed.

Subsequent to step 2A of FIG. 2 the same steps are taken as in case of the process shown in FIG. 1.

With reference to the system of the invention the individual objects, for example buildings, sights may be presented in the home page of the system, or during activation a list of sights of a limited region can be offered to the user of the cellular phone or hand-held computer by means of a GPS device installed on the cellular phone or hand-held computer. Then the user may initiate the process for requesting the information block by selecting an object from the list. The information can be supplied either on-line from a server or off-line from the database previously downloaded in the device.

In both cases it is made possible for the user to add additional material e.g. photo and/or comment to the information block. In this manner an individual character can be given to the information block supplied which later can be used in presentations. In a preferred embodiment it is possible for the tourist (user)—when he returns home—to show the places he visited to others and he can add his own comments, photos to the authentic information. This can be stored and displayed in the form of a modified information block. The system can be adjusted for example so that the user is allowed to store the requested information blocks. The conditions of it can be determined by the service provider, the technical solution of it is not the point of the present invention.

In the following an example for making use of the method and system of the invention is given. Activating codes are sold within the system of the mobile service providers of a country. When a tourist arrives in a country he can buy an activating code at hotels, restaurants, other points of sales or through the internet. With this code he can access the mobile service system of that country. The activating code may be valid for an optional period of time, e.g. one day, one week or even one year. This activation code enables him to call a central phone number (service provider's number) and by entering the activating code in his device he can get registered in the service provider center. At this time by making use of a suitable menu system the language required for communicating the information can be selected and registered. After registration anywhere the visitor sees the symbol of the service provider and the assign code during his traveling in a given region or country, he can call the service provider's number and enter the assign code. Then immediately or after entering some further key commands the digitally registered information relating to a certain object can be heard. In an alternative embodiment or simultaneously with this, a textual information in the form of characters or other additional material, e.g. photos, drawings may be displayed on the display of the cellular phone or hand-held computer.

Hand-held computers can be utilized for example in places where the tourist information service can be accessed via wireless connection (WIFI), through the internet. The already mentioned database is used for supplying the system with information which is based on guide books, brochures or pamphlets or information issued by the owners or managers of the objects. Naturally, technical staff, operators must be applied who provide for uploading of up-to-date information. Further, for technical reasons one or more servers adapted to receive thousands of calls simultaneously in certain cases are needed. A properly structured (e.g. tree structure) menu system can be satisfactory. Thus the caller may decide which object he wants information about, in what language, whether he wants a longer or shorter version, a version for children, etc. In case of off-line mode the peak load is much lower.

To sum it up, it can be said that with the system according to the invention a multilateral, flexible service can be provided for tourists. The users through the mobile service providers or the internet can access so called text conserves prepared in advance.

1. Cellular phone of internet based system for providing information relating to objects of tourism said system comprising subscribers' cellular phones or hand-held computer devices provided with a SIM card; information database containing information blocks; and
assign codes for assigning said information blocks to said objects, wherein one or more information blocks can be selected from said database on the basis of said assign code entered into the cellular phone or hand-held computer device by a user characterized in that said information blocks contain at least textual information in audio or visual form, and the content of said information blocks are activated by entering at least said assign code into the cellular phone or hand-held computer device by the user, the use of said assign codes is enabled by an activating code transmitted to a tourist information supplier previously.

2. Cellular phone system according to claim 1 characterized in that said information database containing said information blocks is installed at the mobile service provider of said subscriber's cellular phone and said information block activated by said assign code is transmitted to the subscriber's cellular phone on-line through a voice transmission channel ensured by said service provider.

3. Cellular phone system according to claim 1 characterized in that said information database containing said information blocks is installed at the mobile service provider of said subscriber's cellular phone and said information block activated by said assign code is transmitted to the subscriber's cellular phone on-line through an SMS transmission channel ensured by said service provider.

4. Cellular phone or internet based system according to claim 1 characterized in that an assign code can be entered by the user into said subscriber's cellular phone or hand-held computer and said cellular phone or hand-held computer is adapted to transmit said assign code to said service provider.

5. Cellular phone system according to claim 1 characterized in that said activating code and said assign code are transmitted to a service provider through SMS.

6. Internet based system according to claim 1 characterized in that said activating code and said assign code are transmitted to a tourist information supplier via the internet or by e-mail.

7. Cellular phone system according to claim 1 characterized in that said activating code and said assign code are transmitted to a service provider by dialing a number and entering said code by means of the keypad.

8. Cellular phone or internet based system according to claim 1 characterized in that a partial database containing several information blocks of said database containing said information blocks is installed in the internal memory of said hand-held computer or subscriber's cellular phone or in the SIM card through a data transmission channel established by the tourist information supplier, said installation is activated by a download code, and on entering an assign code into the cellular phone or hand-held computer by the user the required information block is displayed.

9. Cellular phone system according to claim 8 characterized in that said download code is the activating code.

10. Cellular phone system according to claim 8 or 9 characterized in that said data transmission channel established by said tourist information supplier comprises internet transmission.

11. Cellular phone system according to claim 1 characterized in that said information blocks contain visual information in the form of photos or drawings.

12. Cellular phone or interne based system according to claim 1 characterized in that said information blocks contain photos and/or comments produced by the user.

13. Cellular phone or interne based system according to claim 1 characterized in that said photos and/or comments are produced by means of the user's cellular phone or hand-held computer and are added to a respective information block.

14. Cellular phone or interne based system according to claim 1 characterized in that said tourist information supplier is a mobile service provider.
